(19) United States
(12) Patent Application Publication
(10) Pub. No.: US 2007/0219663 A1
(43) Pub. Date: Sep. 20, 2007

(54) Tracking an Item on a Packaging Line

(76) Inventor: Eddy Verstraeten, Beerse (BE)

Correspondence Address: FISH & RICHARDSON PC, P.O. BOX 1022, MINNEAPOLIS, MN, 55440-1022, US

(21) Appl. No.: 11/618,998

(22) Filed: Jan. 2, 2007

Related U.S. Application Data
(60) Provisional application No. 60/756,022, filed on Jan. 3, 2006.

(51) Int. Cl. G06F 7/00

(52) U.S. Cl. 700/215; 700/225

(57) ABSTRACT

A system for managing a packaging line, the system including a common data-storage system in data communication with a plurality of item-interaction units, the common data-storage system configured for receiving, from the item-interaction units, item data identifying each item in the packaging line, the item data including information indicative of a location of the item within the packaging line; and maintaining the item data in an item database.

### FIELD OF INVENTION

The invention relates to supply chain management, and in particular, to tracking items in a supply chain.

### BACKGROUND

Between the time of its manufacture and the time of its shipment, an item passes certain milestone events. For example, an item may undergo one or more inspections and testing stages. The items may be packed into a container with similar items. This container may also undergo certain milestone events before it too is packed with similar containers into a large container.

The life-cycle of an item on a packaging line is thus marked by a sequence of milestone events. Some of these events are experienced by the item individually. Others are experienced by a collective unit through which the item is associated with other items.

### BRIEF DESCRIPTION OF DRAWINGS

FIG. 1 shows a supply-chain management system;

FIG. 2 shows an item-interaction unit in the system of FIG. 1; and

FIG. 3 shows exemplary data records from a database in the system of FIG. 1.

### DETAILED DESCRIPTION

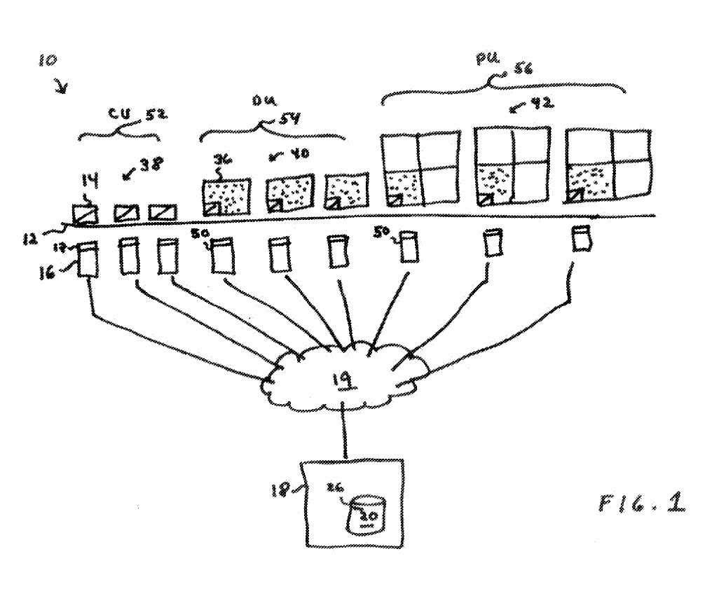

FIG. 1 shows an abstract representation of a packaging line management system 10 for managing a packaging line 12. As an item 14 traverses the packaging line 12, it encounters various stations at which it interacts with an item-interaction unit 16. The item-interaction units 16, each of which is assigned a unique location identifier 17, are in data communication with a common data-storage system 18 over a network 19 (e.g. the internet). This common data-storage system 18 maintains an item database 20 containing item data representative of each item 14 in the packaging line 12. A suitable item database 20 is that created and maintained by COLOS (™), which is a software application sold by Markem Corporation of Keene, N.H.

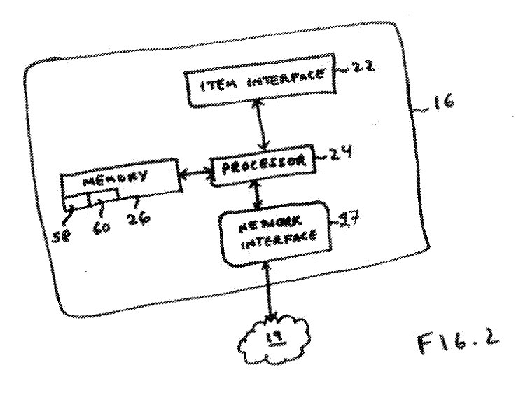

A typical item-interaction unit 16, as shown in FIG. 2, includes an item interface 22 that interacts with an item 14. The item interface 22 communicates the result of that interaction with a local processor 24. The local processor 24 executes business logic, or production logic, for controlling the operation of the item-interaction unit 16 with which it is associated. In addition, the local processor 24 is in communication with an optional local memory 26, for temporary storage of interaction data, and a network interface 27 for transmission of that data to the common data-storage system 18.

The item-interaction units 16 differ primarily in the nature of their respective item interfaces 22. For example, if the item-interaction unit 16 is intended to mark the item 14, then the item interface 22 may include a printer positioned close to a conveyor belt and a photocell to detect entry of the item 14 into a printing zone adjacent to the printer. If the item-interaction unit 16 is intended to weigh the item 14, the item-interaction unit 16 may be a scale. Or, the item-interaction unit 16 may be intended to move the item 14, for example from one conveyor belt to another, or to pick up an item 14 and put it into a box. In this case, the item-interaction unit 16 may include a robotic arm or other mechanical effector.

The item-interaction unit 16 may also include an item-identification unit that generates, reads, or infers item-identifying data from which the identity of the item can be derived. Exemplary item-identification units include bar code scanners, RFID readers, or simply item counters. The identification data can be an EPC code, or a count indexed to an EPC code. The nature of the item-interaction unit 16 depends on details of the packaging line 12.

Following its interaction with an item, the item-interaction unit 16 communicates item data to the local processor 24. Item data provided to the local processor 24 depends on the nature of the item interaction. For example, in the case of a scale, the item data includes data from which the weight of the item can be determined. Typically, item data includes identifying data that identifies the particular item, and result data that indicates the result of the interaction. However, in some cases there is no result data, in which case the item data includes only the identifying data.

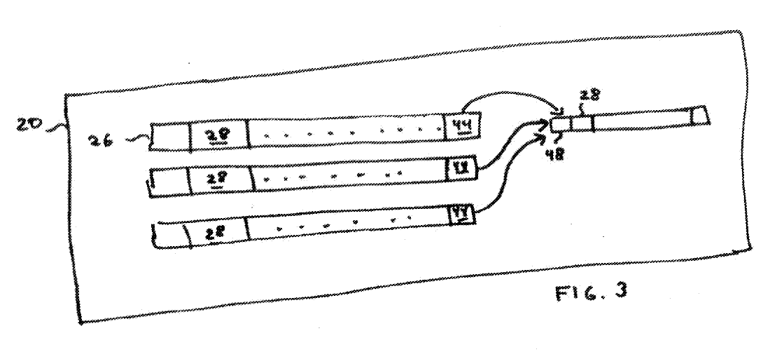

Using the network interface 27, the local processor 24 sends a message to the common data-storage system 18. This message includes the location identifier 17 and the item data In response, the common data-storage system 18 updates an item record 26, shown in FIG. 3, associated with that item 14 in the item database 20. Among the fields in the item record 26 is a location field 28 into which the location identifier 17 can be placed. It is thus possible to determine, from inspecting the item record 26, the most recent item-interaction unit 16 with which a particular item 14 has interacted.

Referring back to FIG. 1 in many cases, items 14 are bundled together with other like items into larger packages, which will be referred to as “super-items 36.” Once this occurs, all items 14 associated with a particular super-item 36 encounter subsequent item-interaction units 16 as a single unit.

For example, following its packaging, after having encountered numerous item-interaction units 16, the consumer unit 38 may join other consumer units 38 in a distribution unit 40. If this occurs, further interactions with item-interaction units 16 will be with the distribution unit 40 and not with the individual consumer units 38 associated with the distribution unit 40. In this case, the consumer unit 38 becomes the item 14 and the distribution unit 40 becomes the super-item 36.

After interacting with additional item-interaction units 16, the distribution unit 40 may join other distribution units 40 in a palette unit 42. If this occurs, subsequent item-interaction units 16 will interact with the palette unit 42 as a whole, rather than with the individual distribution units 40 that it contains. In this case, the item 14 becomes the distribution unit 40 and the super-item 36 becomes the palette unit 42.

The item database 20 maintains item records 26 that identify items 14. Once these items 14 are combined into a super-item 36, any changes to the location of the super-item 36 translate into changes in the location fields 28 of all the item records 26 associated with items 14 in the super-item 36. To avoid the resulting computational burden, the item record 26 can include a super-item field 44 containing a pointer to a super-item record 48. Like the item record 26, the super-item record 48 includes a location field 28 that is updated as the super-item 36 moves through the packaging line 12. Alternatively, the location field 28 of an item record 26 can be used to point to a particular super-item record 48.

The packaging line management system 10 thus features particular item-interaction units 16, referred to as item consolidators 50, whose function is to create a super-item record 48 and to update the item records 26 for all items that are to be consolidated into that super-item 36. In particular, the item consolidators 50 cause the super-item pointer to point to the super-item record 48 into which the item is to be consolidated.

At an abstract level, there is no logical distinction between an item record 26 and a super-item record 48. What makes a super-item record 48 “super” is that there exists an item record 26 that points to it. Thus, from the point of view of the common data-storage system 18, once an item 40 has been grouped with other items into a super-item 36, that super-item 36 can then be treated as an item 14.

In the illustrated packaging line 12, three epochs 52, 54, 56 are shown. In the first epoch 52, which begins with the manufacture of a consumer unit 38, the item 14 is the consumer unit 38 and the super-item 36 is a distribution unit 40. In the second epoch 54, the item 14 becomes the distribution unit 40 and the super-item 36 becomes the palette unit 42. In the third epoch 56, the item 14 is the palette unit 42 and no super-item 36 is shown. However, it is apparent that the packaging line 12 can have any number of epochs.

The hierarchical item database 20 thus simplifies the task of tracking the location of a particular consumer unit 38 by eliminating the need to update item records 26 of each consumer unit 38 in a bundled set of consumer units 38.

In addition, the location of any item 14 can readily be determined by beginning with the item record 26 for that item and checking the location field 28 of that item record 26. If the location field 28 indicates that the item 14 has been consolidated into a super-item 36, one can follow the pointer to that super-item 36. This procedure continues recursively until one reaches an item record 26 that does not point to a super-item 36.

Note that the procedure for identifying a location of an item 14 does not require that the item 14 be a consumer unit 38. The procedure can thus be initiated anywhere along the packaging line 12.

The process of communicating item data to the common data-storage system 18 can include time-consuming steps. In some cases, an item-interaction unit 16 interacts with items very quickly. In these cases, item records 26 may be generated more quickly than they can be communicated to the common data storage system 18. To prevent the latency of data transfer from becoming a bottle neck, item data can be accumulated temporarily in the local memory 26. As a result, communication of item records 26 from the local memory 26 to the common data storage system 18 can occur asynchronously. For example, the local processor 24 can cause transmission of several item records 26 simultaneously to the common data storage system 18.

In one embodiment, the local memory 26 is divided into first and second partitions 58, 60. When the item data accumulated in the local memory 26 fills the first partition 58, additional item data is saved in the second partition 60. Meanwhile, the local processor 24 sends a message to the common data-storage system 18 requesting that the accumulated item data in the first partition 58 be uploaded to the item database 20. The local processor 24, which then continues to collect item data in the second partition 60. When the common data-storage system 18 completes the upload, it sends a confirming message to the local processor 24, which then clears the first partition 58. This enables the item-interaction unit 16 to continuously interact with items in the packaging line 12 without having to wait for data transmission to complete.

In other cases, the common data-storage system 18 may not upload the data before the second partition 60 becomes full. With both first and second partitions 58, 60 of the local memory 26 now full, it may become necessary to stop the production line to wait for the uploading process to complete. To avoid this, certain embodiments have local memories 26 partitioned into additional partitions. The local processor 24 can then messages to the common data-storage system 18 with the filling of each such partition. Each such message would have an urgency associated with it, with the urgency being related to how many partitions remain to be filled.

The system described herein is adapted to track an item on a packaging line. However, the system is readily adaptable to tracking an item in, for example, a production line, a manufacturing line, or an assembly line, or any similar environment. In addition, the system described herein does not depend on any institutional boundaries. Thus, in some embodiments, the common data storage may be accessible to two or more different business organizations or other institutions. In that case, the system tracks an item through an entire supply chain, from its manufacture, through its packaging at the manufacturer's site, and continuing on through the warehousing and distribution process until the item eventually finds its way into the hands of the ultimate consumer.

Having described the invention, and a preferred embodiment thereof, we now claim as new, and secured by letters patent:

1. A system for managing a packaging line, the system comprising:
a common data-storage system in data communication with a plurality of item-interaction units, the common data-storage system configured for
receiving, from the item-interaction units, item data identifying each item in the packaging line, the item data including information indicative of a location of the item within the packaging line; and
maintaining the item data in an item database.

2. The system of claim 1, wherein the item data includes information leading to a super-item into which an item has been consolidated with other items.

3. The system of claim 2, wherein the information leading to a super-item comprises information identifying a distribution unit; and wherein the item data identifies a consumer unit.

4. The system of claim 2, wherein the information leading to a super-item comprises information identifying a palette unit, and wherein the item data identifies a distribution unit.

5. The system of claim 1, wherein the item data comprises an item record having a location field for storing information indicative of the location of the item within the packaging line.

6. The system of claim 5, wherein the item record further comprises a super-item field containing the information leading to a super-item.

7. The system of claim 5, wherein the information leading to a super-item is stored in the location field.

8. The system of claim 1, wherein the common data-storage system is configured to receive item data for multiple items in a single transaction with an item-interaction unit.

9. The system of claim 1, wherein the common data-storage system is configured to receive item data asynchronously with the acquisition of the item data by the item-interaction unit.

10. A method for managing a packaging line, the method comprising:
receiving item data from one of a plurality of item-interaction units,
the item data identifying an item in the packaging line and indicating a location of that item in the packaging line; and
maintaining the item data in an item database.

11. The method of claim 10, wherein receiving item data comprises receiving information leading to a super-item into which an item has been consolidated with other items.

12. The method of claim 11, wherein receiving item data comprises receiving data identifying a consumer unit and receiving data leading to a distribution unit.

13. The method of claim 11, wherein receiving item data comprises receiving data identifying a distribution unit, and receiving data leading to a palette unit.

14. The method of claim 10, wherein maintaining the item data in an item database comprises storing, in a location field of an item record, information indicative of the location of the item within the packaging line.

15. The method of claim 14, wherein maintaining the item data in an item database further comprises storing, in a super-item field of the item record, information leading to a super-item.

16. The method of claim 14, wherein maintaining the item data in an item database further comprises storing, in the location field of the item record, information leading to a super-item.

17. The method of claim 10, wherein receiving item data comprises receiving item data for multiple items in a single transaction with an item-interaction unit.

18. The method of claim 10, wherein receiving item data comprises receiving item data asynchronously with the acquisition of the item data by the item-interaction unit.
